(19) United States
(12) Patent Application Publication
(10) Pub. No.: US 2012/0271775 A1
(43) Pub. Date: Oct. 25, 2012

(54) SYSTEMS, METHODS, APPARATUS AND GRAPHICAL USER INTERFACES FOR IMPROVED CANDIDATE SEARCH AND SELECTION AND RECRUITMENT MANAGEMENT

(76) Inventors: GAVIN BELL, New South Wales (AU); Richard Michael Hillberg, New South Wales (AU)

(21) Appl. No.: 13/267,428

(22) Filed: Oct. 6, 2011

(30) Foreign Application Priority Data
Apr. 20, 2011 (AU) 2011201800

(51) Int. Cl. G06Q 10/06

(52) U.S. Cl. 705/321

(57) ABSTRACT

A system (200) for short-listing one or more suitable candidates for an employment role and for recruitment management comprises a data store (280) in communication with a communications network (210) for storing information relating to a plurality of potential candidates for employment in one or more roles. A processor (240) operatively coupled to the data store populates an organizational chart of an employer with information relating to one or more roles with the employer, a number of the potential candidates for each role, and a number of matched candidates for each role from the number of potential candidates to indicate a level of ease or difficulty in filling the role. Methods, apparatus and GUIs for performing the above and for short-listing suitable candidates for employment in a role are also disclosed.

### FIELD OF THE INVENTION

The present invention relates to systems, methods, apparatus and graphical user interfaces for improved candidate search and selection and recruitment management. In particular, but not exclusively, the present invention relates to computer implemented tools for improved searching, identification, filtering, selection and placement of candidates for employment roles.

### BACKGROUND TO THE INVENTION

The selection of candidates for employment positions can be both a time-consuming and expensive exercise. Once selection criteria for a particular role have been established, typically advertising in appropriate for a, such as newspapers, online and/or industry-focussed publications, is undertaken and/or the services of a recruitment consultant are engaged. Candidates with the appropriate skills and experience for the employment role must then be identified from a larger pool of prospective candidates. One or more rounds of interviews are subsequently undertaken by the recruitment consultant and the employer before an offer is made to the preferred candidate(s). This process typically takes 6 weeks and often longer. The process is time consuming for staff of the employer and the employer incurs fees charged by the recruitment consultant for their services. Productivity is also lost whilst the role with the employer remains unoccupied. Furthermore, if an unsuitable candidate is employed, further productivity is lost and further expense is incurred by having to repeat the recruitment process.

Hence, there is a need to improve the efficiency of the recruitment process, reduce costs if possible and improve the likelihood of recruiting the most suitable candidate for the vacancy.

It is known to verify candidates' credentials and qualifications, for example with former employers, educational institutions and law enforcement agencies prior to inclusion in a pool of potentially suitable candidates, but these processes do not sufficiently address the aforementioned problems.

Websites are also known which advertise a range of employment roles available with a range of typically unidentified companies and candidates can search for roles they consider desirable or consider appropriate to their set of skills. Candidates then apply for the employment role to the recruitment agency operating the website. Alternatively, websites are also known which list CVs provided by multiple candidates and potential employers can conduct word searches of the CVs for potentially suitable candidates. However, whilst these two types of website provide convenient fora for both candidates and potential employers, both of these options also fail to sufficiently address the aforementioned problems. This is because with the first kind of website, employers will still receive applications from candidates with a range of skills and experience, many of whom will be unsuitable for the employment role. With the second kind of website, candidates are essentially selling themselves to potential employers and CVs do not always accurately reflect the candidates' true skills and experiences especially compared to other candidates in the market, which leads to a mismatch between employers' needs and potential candidates' capabilities.

WO 1998/039716 discloses systems and methods which endeavour to address some of the aforementioned problems. A central database stores requirement information of potential employers for positions available with the potential employers and candidate information from a number of candidates. For an available position having specific requirement information, information is retrieved from the database for a pool of candidates. The academic qualifications and skills of each candidate are checked against the requirements of the positions and the candidates' preferences are also checked against a description of the position. Only candidates satisfying all three of these checks make a list of acceptable candidates for review by the potential employer. A coordinating system communicates with a remote database, such as that of an academic institution, to check the accuracy of the academic qualifications. Inaccurate qualifications provided by the candidate can result in rejection of the candidate. The coordinating system may also receive skill information from a career office which evaluates a candidate's skills.

The systems and methods of WO 1998/039716 improve the efficiency of the recruitment process to an extent and aim to reduce the likelihood of a mismatch between the candidate and the available position. However, since candidates attend a very wide range of academic institutions, the qualification verification feature would require the system to communicate with remote databases of all academic institutions, both nationally and internationally, which creates a large implementation burden. There is also no uniformity regarding the evaluation of candidates' skills. One career office may consider a candidate to possess good management skills, whereas another career office may consider the same management skills to be average. Therefore, candidates can be incorrectly included in, or omitted from, the list of acceptable candidates. Other problems employers experience are uncertainty regarding how long it may take to refill a role once it becomes vacant, how many candidates may be available to choose from and the remuneration package required to secure the services of the desired candidate(s). These issues can severely impact on business operations particularly when key personnel leave a role unexpectedly. These issues also make it difficult for employers to manage their budgets.

Hence, there is also a need to improve the management of the recruitment process and/or reduce uncertainty wherever possible.

In this specification, the terms “comprises”, “comprising”, “includes”, “including” or similar terms are intended to mean a non-exclusive inclusion, such that a method, system or apparatus that comprises a list of elements does not include those elements solely, but may well include other elements not listed.

### SUMMARY OF THE INVENTION

Generally, embodiments of the present invention relate to computer implemented systems, methods, apparatus and graphical user interfaces comprising, or in communication with, a database of filtered information relating to candidates for employment in one or more roles, at least some of the filtered information being used to populate an organizational chart of an employer to indicate a level of ease or difficulty in filling one or more roles.

The filtering of information and matching of candidates to roles can be performed before a role becomes available or whilst an existing role is still occupied to inform employers in advance how long it may take to refill a role once it becomes vacant, how many suitable candidates may be available to choose from and the remuneration package likely to be required to secure the services of the desired candidate(s). This can be updated regularly such that up-to-the minute data is provided.

Such embodiments of the present invention improve the efficiency and management of the recruitment process by reducing the time taken to identify suitable candidates, reducing costs and uncertainty and improving the likelihood of recruiting the most suitable candidates for roles by focusing on higher quality candidates.

According to one aspect, but not necessarily the broadest aspect, the invention resides in a computer-implemented method of recruitment management, the method including: storing in a data store information relating to a plurality of potential candidates for employment in one or more roles; populating an organizational chart of an employer with information relating to one or more roles with the employer and a number of the potential candidates for each role, the organizational chart being linked to the data store; and populating the organizational chart with a number of matched candidates for each role from the number of potential candidates to indicate a level of ease or difficulty in filling the role.

The one or more roles may be new roles, existing roles, currently vacant roles or currently occupied roles. Hence, population of the organizational chart can be performed prior to a vacancy becoming available.

Suitably, one or more potential candidates can be added to a shortlist of matched candidates, for example, by the employer.

Preferably, the method includes filtering the potential candidates and categorizing a potential candidate as a matched candidate for a role when the potential candidate possesses a threshold level of capability in a threshold number of facets comprising the role.

Preferably, filtering potential candidates includes assessing a number of facets comprising the role in which a potential candidate possesses capability.

Suitably, the potential candidate may need to possess the threshold level of capability in all of the facets comprising the role to be categorized as a matched candidate for the role.

The method preferably includes attributing one or more search terms to each matched candidate, each search term matching a capability, attribute or experience possessed by the matched candidate to the threshold level.

The method may include assessing whether a potential candidate possesses capability in a general industry sector in which the role resides.

The method may further include attributing a score to the candidate indicative of the candidate's level of capability for the role, wherein the score is based on the candidate's responses to a plurality of questions, each question assessing the candidate's capability in at least one facet of the role.

Suitably, the score indicative of the candidate's level of capability for the role is based on the sum of weighted scores for each facet comprising the role.

The method may include providing the candidate with feedback on their assessment including a comparison of the candidate's scores with ideal scores for each facet of the role.

The method may include determining a value for money of the candidate by calculating a ratio of a current salary for the candidate to the candidate's score indicative of the candidate's level of capability for the role.

Suitably, the method includes storing in the data store the results of at least one salary survey.

Suitably, the method includes populating an operational cost analysis chart of an employer with an estimated additional salary derived from the salary survey and required to match an average national/market salary for a role.

Suitably, the method includes populating the operational cost analysis chart with one or more of the following: an estimated recruitment cost to fill a role; a total cost to fill a role.

Suitably, the method includes populating a report relating to candidates engaged by an employer with one or more of the following: a role; a role ID, a role status, such as filled or open; a role type, such as permanent, interim or contractor; a hiring manager; a number of matched candidates sent to the employer; a number of matched candidates interviewed by the employer; a number of days before receiving a CV; a number of days until the candidate is interviewed by the employer; a number of days taken to fill the role; a start date for the role, a fee paid for filling the role; a percentage of annual salary represented by the fee; a candidate name; an engagement method, e.g. recruiter's payroll; a contract start date; a contract end date; a rate per hour; a cost to date.

According to another aspect, but not necessarily the broadest aspect, the invention resides in an apparatus for recruitment management, the apparatus comprising computer readable program code components configured to cause: storing in a data store information relating to a plurality of potential candidates for employment in one or more roles; populating an organizational chart of an employer with information relating to one or more roles with the employer and a number of the potential candidates for each role, the organizational chart being linked to the data store; and populating the organizational chart with a number of matched candidates for each role from the number of potential candidates to indicate a level of ease or difficulty in filling the role.

According to a further aspect, but not necessarily the broadest aspect, the invention resides in a system for recruitment management, the system comprising: a data store in communication with a communications network for storing information relating to a plurality of potential candidates for employment in one or more roles; and at least one processor operatively coupled to the data store for: populating an organizational chart of an employer with information relating to one or more roles with the employer and a number of the potential candidates for each role; and populating the organizational chart with a number of matched candidates for each role from the number of potential candidates to indicate a level of ease or difficulty in filling the role.

According to a yet another aspect, but not necessarily the broadest aspect, the invention resides in a graphical user interface for recruitment management in communication with a data store storing information relating to a plurality of potential candidates for employment in one or more roles, the graphical user interface displaying: one or more fields comprising information relating to one or more roles with an employer; a searchable field comprising a number of potential candidates for each role selected from the data store; and a searchable field comprising a number of matched candidates for each role selected from the number of potential candidates to indicate a level of ease or difficulty in filling the role.

In the aforementioned systems, methods, apparatus and graphical user interfaces, the number of matched candidates can be categorized in a plurality of different categories.

Suitably, the plurality of different categories relate to the status of the matched candidates.

Preferably, the electronic organizational chart comprises a plurality of searchable fields relating to the status of the matched candidates for each role.

In preferred embodiments, the electronic organizational chart comprises a first searchable field for active matched candidates, a second searchable field for available matched candidates and a third searchable field for passive matched candidates.

According to a further aspect, but not necessarily the broadest aspect, the invention resides in a graphical user interface for recruitment management in communication with an electronic data store storing information relating to a plurality of roles and a plurality of potential candidates for employment in one or more of the roles, the graphical user interface displaying to a potential candidate information relating to at least one role matched to the potential candidate; wherein the potential candidate has been matched to the at least one role on the basis of a plurality of matching criteria relating to the role and to the potential candidate, one of the criterion being a role ID and another of the criterion being selected from one or more of the following: a location criterion and/or a salary criterion.

The at least one role may be displayed to the potential candidate on the basis of all three criteria being matched between the role and the potential candidate.

Suitably, the location criterion is one or more of the following: a location in which the potential candidate resides and/or a location in which the candidate wishes to work.

Suitably, the salary criterion includes a salary for the role being within a predetermined amount of a salary desired by the potential candidate, such as ±10%.

Suitably, the information relating to at least one role matched to the potential candidate includes one or more of the following: a role; a role ID, a company name; a role status; a role type; a location; a salary; a start date for the role.

The graphical user interface can further display information relating to a role application history for the potential candidate, such as one or more of the following: a role; a role ID; a company name; an interview date; a placement date.

According to another aspect, but not necessarily the broadest aspect, the invention resides in a computer-implemented method of short-listing one or more suitable candidates for employment in a role, the method including: storing in a data store one or more search terms for each suitable candidate, each search term matching a capability, attribute or experience possessed by the suitable candidate, wherein each suitable candidate possesses a threshold level of capability in a threshold number of facets comprising the role; receiving a search query submitted, for example, by a potential employer via a website in communication with the data store, the website accessible via a computing device in communication with a communications network; and retrieving information for at least one suitable candidate from the data store in response to the search query where at least one search term for the suitable candidate matches at least one search criterion of the search query.

Other aspects of the invention include an apparatus, system and graphical user interface for executing the aforementioned method of short-listing one or more suitable candidates for employment in a role.

According to a further aspect, but not necessarily the broadest aspect, the invention resides in an apparatus for recruitment management comprising computer readable program code components configured to cause: storing in an electronic data store information relating to a plurality of potential candidates for employment in one or more roles; attributing a score to each candidate indicative of the candidate's level of capability for the role, wherein the score is based on the candidate's responses to a plurality of questions, each question assessing the candidate's capability in at least one facet of the role; and populating an electronic organizational chart of an employer linked to the data store with: information relating to one or more roles with the employer; a number of the potential candidates for each role; and a number of matched candidates for each role selected from the number of potential candidates to provide an employer with an indication of a level of ease or difficulty in filling the role.

Further aspects and features of embodiments of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a schematic diagram illustrating a computing device for use with embodiments of the present invention;

FIG. 2 is a schematic diagram illustrating a system for short-listing candidates and recruitment management in accordance with embodiments of the present invention;

FIG. 3 is a screenshot illustrating a graphical user interface showing an organizational chart according to embodiments of the present invention;

FIG. 4 is a screenshot illustrating the graphical user interface of FIG. 3 showing details of a role with an employer;

FIG. 5 is a screenshot of the graphical user interface of FIG. 3 showing details of a potential candidate;

FIG. 6 is a screenshot of the graphical user interface of FIG. 3 showing details of a matched candidate;

FIG. 7 is a screenshot of the graphical user interface of FIG. 3 showing an operational cost analysis chart;

FIGS. 8 and 9 are screenshots of the graphical user interface of FIG. 3 showing reports relating to candidates engaged by an employer;

FIG. 10 is a general flow diagram illustrating a method of filtering potential candidates and recruitment management according to embodiments of the present invention;

FIG. 11A is a schematic diagram illustrating a method of filtering potential candidates for employment in specific role descriptions in accordance with some embodiments of the present invention;

FIG. 11B is another schematic diagram illustrating a method of filtering potential candidates for employment in specific role descriptions;

FIG. 11C is a further schematic diagram illustrating a method of filtering potential candidates for employment in specific role descriptions;

FIG. 11D is another schematic diagram illustrating a method of filtering potential candidates for employment in specific role descriptions;

FIG. 12 is a general flow diagram illustrating a method of short-listing one or more suitable candidates according to some embodiments of the present invention;

FIGS. 13 and 14 are screenshots illustrating a graphical user interface in accordance with embodiments of the present invention;

FIG. 15 is a screenshot illustrating a graphical user interface showing an organizational chart according to other embodiments of the present invention;

FIG. 16 is a screenshot illustrating a graphical user interface for candidates according to other embodiments of the present invention; and

FIG. 17 shows an example of a score sheet for assessing candidates' capabilities for a role.

Skilled addressees will appreciate that elements in the drawings are illustrated for simplicity and clarity, may be schematic and have not necessarily been drawn to scale. For example, the relative dimensions of some of the elements in the drawings may be distorted to help improve understanding of embodiments of the present invention.

### DETAILED DESCRIPTION OF THE INVENTION

As will be described in detail herein, embodiments of the present invention comprise systems, methods, apparatus and graphical user interfaces comprising, or in communication with, a data store of filtered information relating to candidates for employment in one or more roles, wherein at least some of the filtered information is used to populate an organizational chart of an employer to indicate a level of ease or difficulty in filling one or more roles.

The filtering of information and matching of candidates to roles can be performed before a role becomes available or whilst an existing role is still occupied and is updated regularly to inform employers in advance how long it may take to refill a role once it becomes vacant, how many suitable candidates may be available to choose from and the remuneration package likely to be required to secure the services of the desired candidate(s). Such embodiments of the present invention improve management of the recruitment process by reducing the time taken to identify suitable candidates, reducing costs and uncertainty and improving the likelihood of recruiting the most suitable candidates for roles.

Employers can also search details of potential candidates stored in the data store via a website, portal or the like in communication with the data store for candidates matched for employment in a specified role. According to preferred embodiments, the matched candidates have been assessed to ensure they possess a threshold level of capability in a threshold number of facets comprising the specified role.

Embodiments of the present invention will be described with reference to employment roles in the fields of procurement, supply chain, category management, purchasing, logistics, planning, analytics and consulting. However, it will be appreciated that the present invention is not limited to such employment roles and the present invention could be used in relation to managing recruitment of candidates for any employment roles.

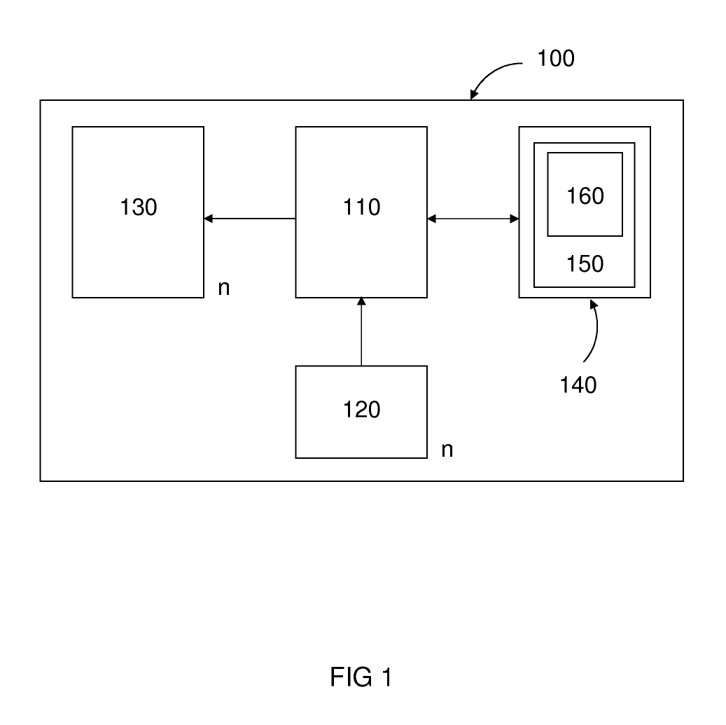

Referring to FIG. 1, a schematic diagram illustrates a computing device 100 for use with the systems, methods, apparatus and graphical user interfaces according to embodiments of the present invention. Examples of computing device 100 include, but are not limited to, personal, laptop, netbook or notebook computers, personal digital assistants (PDAs), portable multimedia devices, mobile telephones and other computing devices.

The computing device 100 comprises a processor 110 operatively coupled to one or more input devices 120, such as a keyboard, mouse, touch screen, joystick, controller and/or other suitable input device. Processor 110 is operatively coupled to one or more output devices 130, such as a screen, printer and/or other suitable output device. Processor 110 is also operatively coupled to a storage medium in the form of memory 140.

Memory 140 comprises a computer readable medium 150, such as a read only memory (e.g., programmable read only memory (PROM), or electrically erasable programmable read only memory (EEPROM)), a random access memory (e.g. static random access memory (SRAM), or synchronous dynamic random access memory (SDRAM)), or hybrid memory (e.g., FLASH), or other types of memory as are well known in the art. The computer readable medium 150 comprises computer readable program code components 160, at least some of which are selectively executed to cause the execution of embodiments of the present invention described herein.

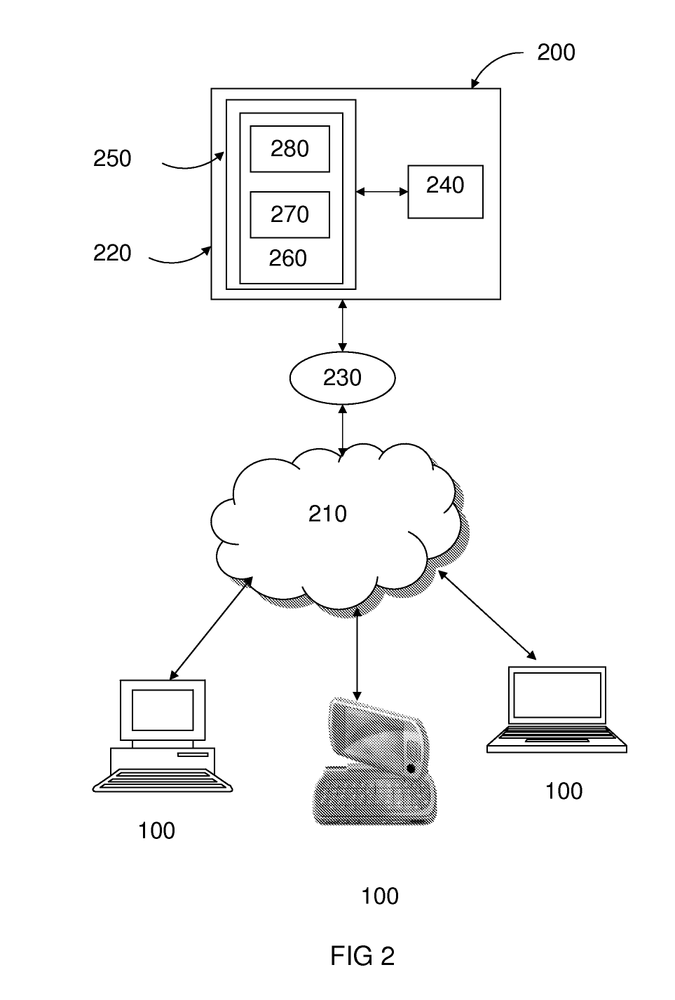

Referring to FIG. 2, a schematic diagram illustrates a system 200 for short-listing one or more suitable candidates for employment in a role and recruitment management in accordance with embodiments of the present invention. The system 200 comprises one or more computing devices 100 as described above coupled to be in communication with a communications network 210, such as a local area network (LAN) and/or a global communications network, such as the Internet, via conventional wireless and/or wired connections as are well known in the art. Computing devices 100 can be coupled to be in communication with an apparatus 220, such as a server or other computing device, via communications network 210, when computing devices access apparatus 220 via a website 230.

Apparatus 220 comprises a processor 240 operatively coupled to a storage medium in the form of memory 250. Memory 250 comprises a computer readable medium 260, such as those described above in relation to computer readable medium 150. Computer readable medium 260 comprises computer readable program code components 270 for short-listing one or more suitable candidates for employment in a role and for performing recruitment management in accordance with the teachings of the present invention. At least some of computer readable program code components 270 are selectively executed by the processor 240 and are configured to cause the execution of the embodiments of the present invention described herein.

Computer readable medium 260 of apparatus 220 also comprises an electronic data store 280 for storing data relating to candidates and short-listing one or more matched candidates for employment in a role in accordance with embodiments of the present invention described herein. For example, data store 280 can store an identifier for each candidate, such as a Candidate ID in the form of a unique number. Data store 280 can store information relating to each candidate including, but not limited to, one or more of the following: a name; an address; a current state or other locality indicator; a desirable state or other locality indicator; qualifications; affirmative or negative indicators regarding a level of qualification or education, such as Degree?=YES/NO; a current salary package; a desirable salary package; current work status, such as permanently employed, employed part-time, unemployed; a preferred role type, such as permanent employment or part-time employment; languages spoken, optionally including a level of fluency; a list of skills and experience. Data store 280 can be in the form of an SQL database although other forms of database familiar to those skilled in the art could be employed.

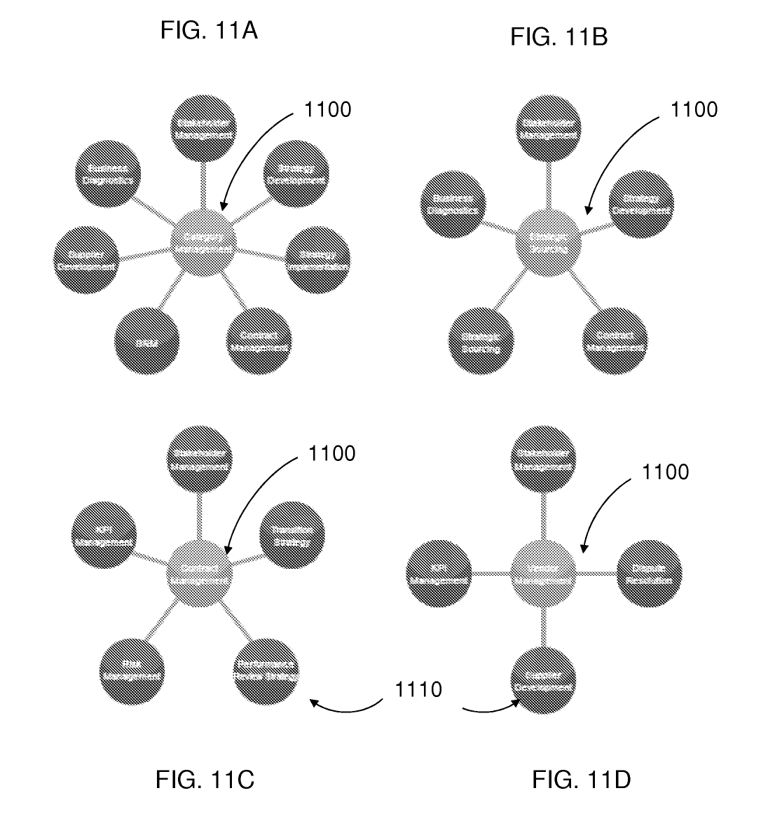

According to preferred embodiments, the skills and experience of each candidate are in the form of one or more search terms attributed to each candidate, each search term matching a capability, attribute or experience possessed by the matched candidate to the threshold level. Examples of search terms in the fields of procurement and supply chain that may be attributed to potential candidates depending on the capabilities possessed to the threshold level are shown in the Appendix. The Appendix also shows examples of role definitions in the fields of procurement, supply chain, category management, purchasing, logistics, planning, analytics and consulting. The Appendix also shows examples of industry definitions used in embodiments of the present invention to align procurement and supply chain practitioners with common environmental and cultural experiences whilst providing potential employers sufficient diversity to identify candidates with more specific industry experience. Further details of analyzing and categorizing candidates are described herein with reference to FIGS. 11A to 14.

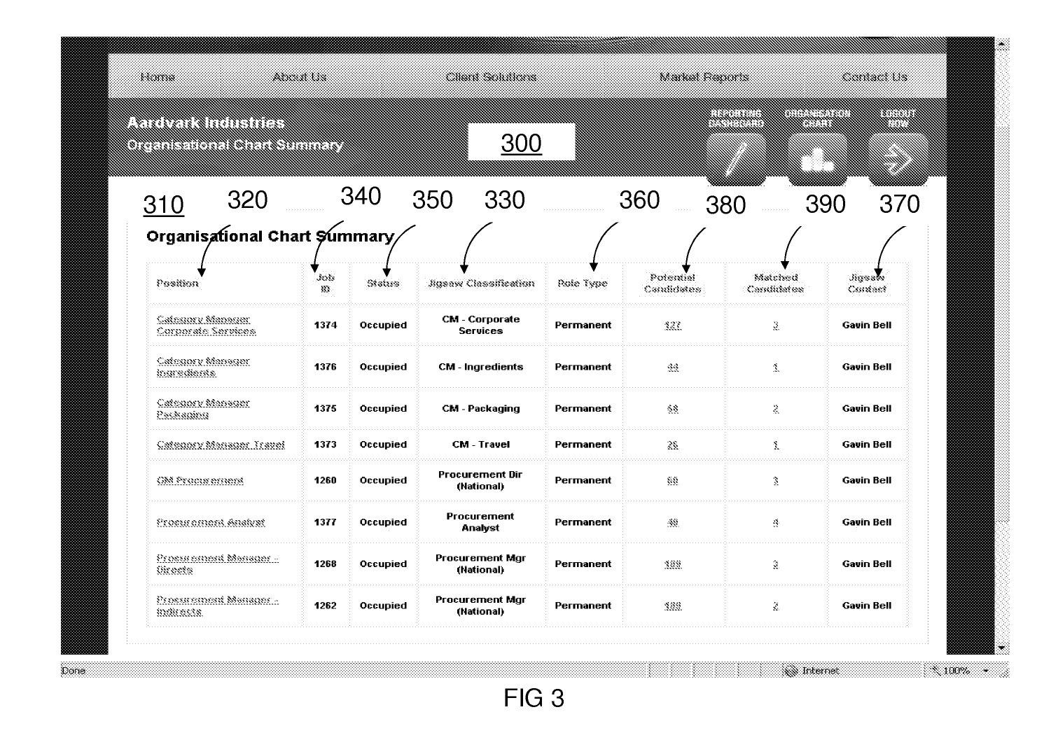

FIG. 3 shows a graphical user interface (GUI) 300 for recruitment management, which is accessible via communication devices 100 via communication network 210 and website or portal 230. GUI 300 is in communication with data store 280, which stores information relating to a plurality of potential candidates for employment in one or more roles as described above.

In FIG. 3, GUI 300 is displaying an organizational chart 310 having one or more fields 320 comprising information relating to one or more roles with an employer. In this example, the organizational chart 310 for employer Aardvark Industries comprises eight fields 320 each comprising a role or position with the company. The labels for the roles used in fields 320 are those used by the employer. The requirements of the role are analyzed and the role descriptions classified according to the terms and definitions listed in the Appendix. The classified roles appear in respective fields 330 (entitled Jigsaw Classification) for each role.

Organizational chart 310 also comprises the following fields for each role: field 340 comprising a Job ID—a unique identifier within the system for the role; field 350 comprising a status of the role, such as occupied or vacant; field 360 comprising a role type, such as permanent, interim or contract; field 370 comprising a recruiter contact. Organizational chart 310 also comprises a searchable field 380 for each role comprising a number of potential candidates for each role selected from the data store 280. For example, for the role of Category Manager (CM)—Corporate Services, there are 127 potential candidates. Field 380 has been populated with this number following a comparison of the role requirements with the skills and experience of each candidate stored in the data store 280.

Organizational chart 310 also comprises a searchable field 290 for each role comprising a number of matched candidates for each role selected from the number of potential candidates. This further filtering is preferably performed by employing the matching protocols described in further detail herein with reference to FIGS. 11A to 14 wherein the capabilities, attributes and/or experience required for the role is/are possessed by the matched candidate to the threshold level. In this example, for the role of Category Manager (CM)—Corporate Services, only 3 of the 127 potential candidates qualify as matched candidates, which indicates to the employer a level of ease or difficulty in filling the role.

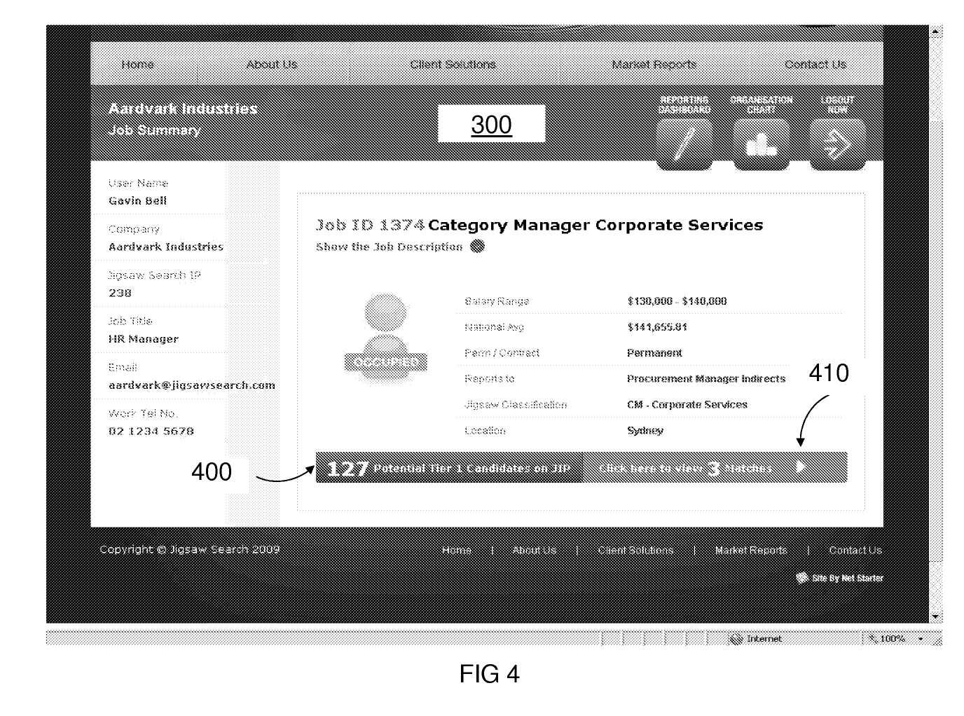

If a user, such as an employer to whom the organizational chart 310 relates, activates field 320 comprising the role information, GUI 300 displays further information relating to the role as shown in FIG. 4. In particular, this can include a salary range, a national average salary for the role derived from at least one salary survey stored in the data store 280, and the location of the role. In FIG. 4, GUI 300 also comprises an actuatable icon 400 linking to the 127 potential tier 1 candidates and actuatable icon 410 linking to the 3 matched tier 1 candidates.

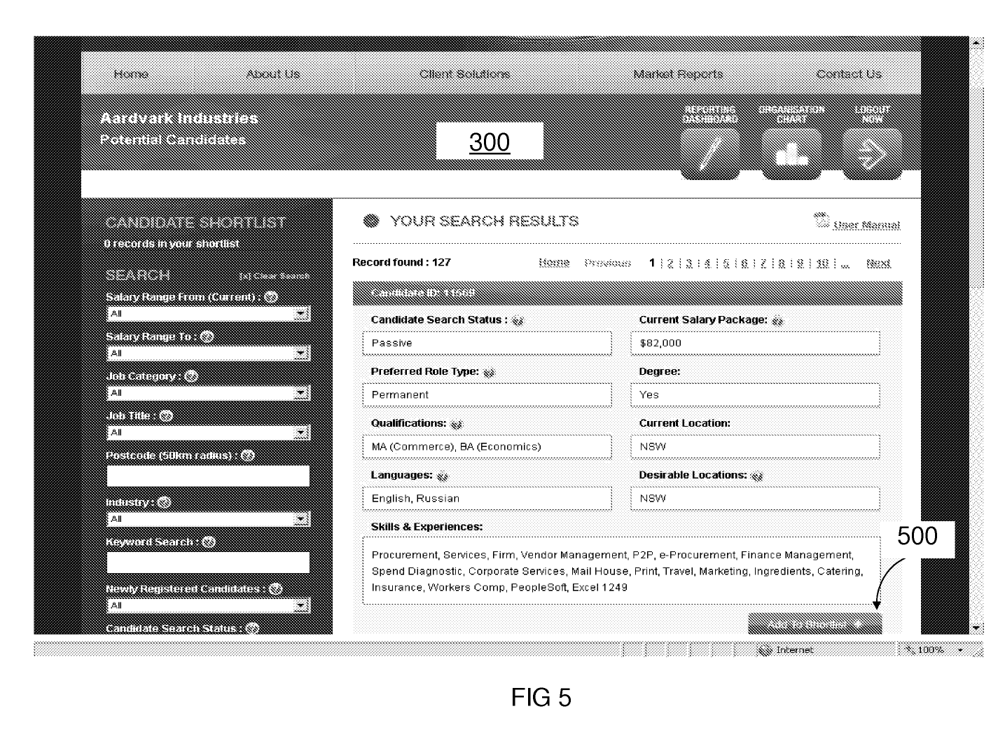

Actuating icon 400 causes the GUI 300 to display the records for each of the 127 potential candidates for this role as shown in FIG. 5. The records can be scrolled through and viewed as required by the user and, for example, an employer can add any of the potential candidates to their shortlist for the role by activating icon 500.

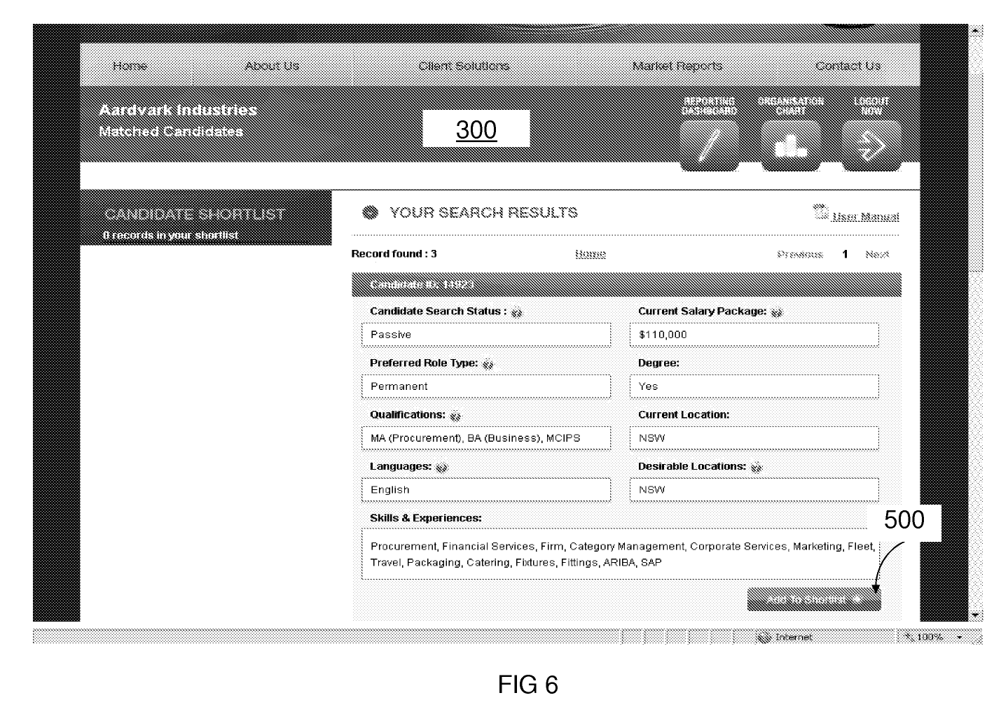

Actuating icon 410 causes the GUI 300 to display the records for each of the 3 matched candidates for this role as shown in FIG. 6. The records can be scrolled through and viewed as required by the user and any of the matched candidates can be added to the employer's shortlist for the role by activating icon 500.

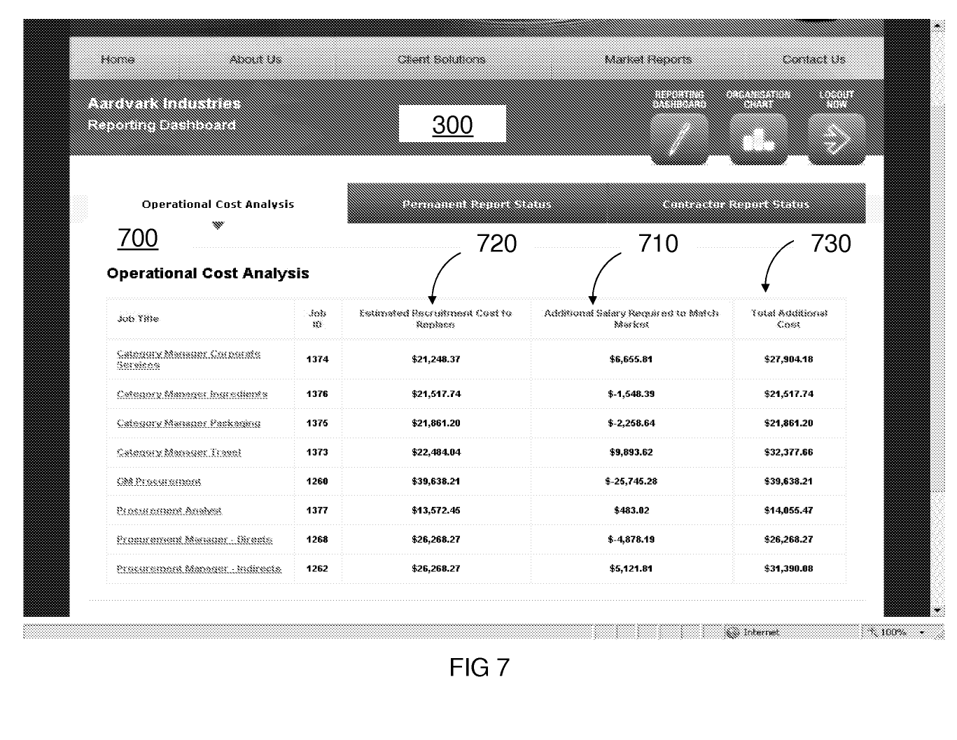

Referring to FIG. 7, GUI 300 can display an operational cost analysis chart 700 of an employer to enable employers to easily track recruitment costs. Operational cost analysis chart 700 comprises an estimated additional salary field 710 for each role, which is populated with an estimated additional salary required to match an average market salary for a respective role. The estimated additional salary value is derived from the results of one or more salary surveys stored in data store 280. Therefore, the employer can immediately see how much more they are likely to need to pay to secure the matched candidate identified by the system. A negative value for the estimated additional salary value indicates that the salary suggested for the role by the employer is above the national/market average.

The operational cost analysis chart 700 can also comprise an estimated recruitment cost to replace field 720 for each role, which is populated with an estimated recruitment cost to fill a respective role, such as the recruiter's fee.

The operational cost analysis chart 700 can also comprise a total cost field 730 for each role, which is populated with the sum of the respective estimated recruitment cost and the respective estimated additional salary value.

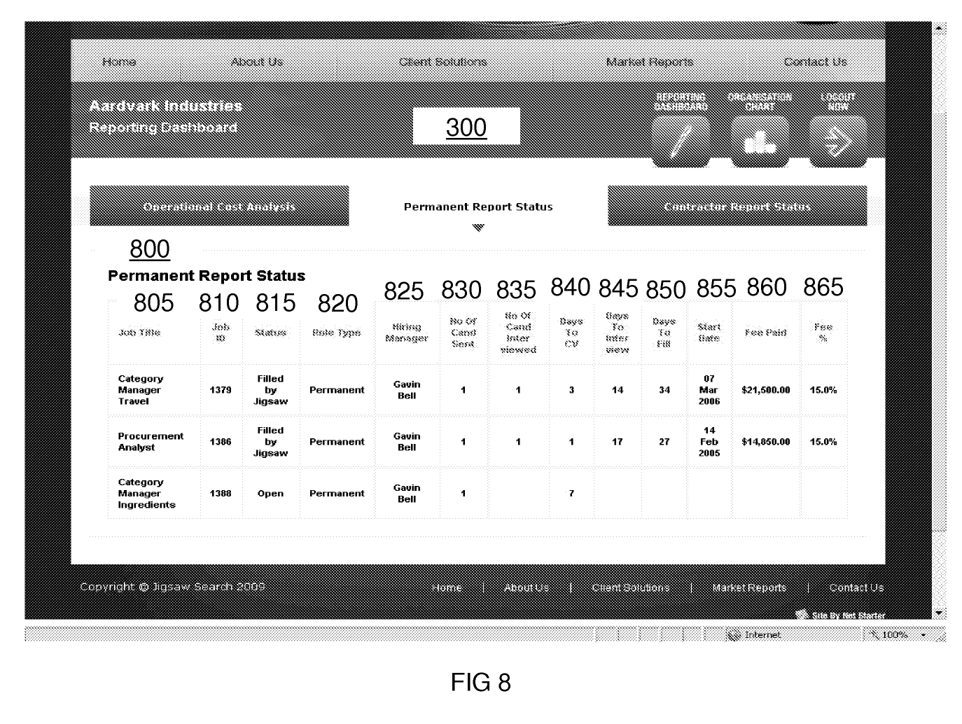

GUI 300 can display one or more reports relating to candidates engaged by an employer. With reference to FIG. 8, GUI 300 can display report 800 relating to candidates employed in permanent roles with an employer. Report 800 comprises the following for each role: field 805 comprising a role title or name, such as procurement analyst; field 810 comprising a role ID; field 815 comprising a role status, such as filled by the recruiter or open; 820 comprising a role type, such as permanent, interim or contractor; field 825 comprising the name of a hiring manager; field 830 comprising a number of matched candidates sent to the employer; field 835 comprising a number of matched candidates interviewed by the employer; field 840 comprising a number of days before receiving a CV; field 845 comprising a number of days until the candidate is interviewed by the employer; field 850 comprising a number of days taken to fill the role; field 855 comprising a start date for the role; field 860 comprising a fee paid for filling the role; and field 865 comprising a percentage of annual salary represented by the fee.

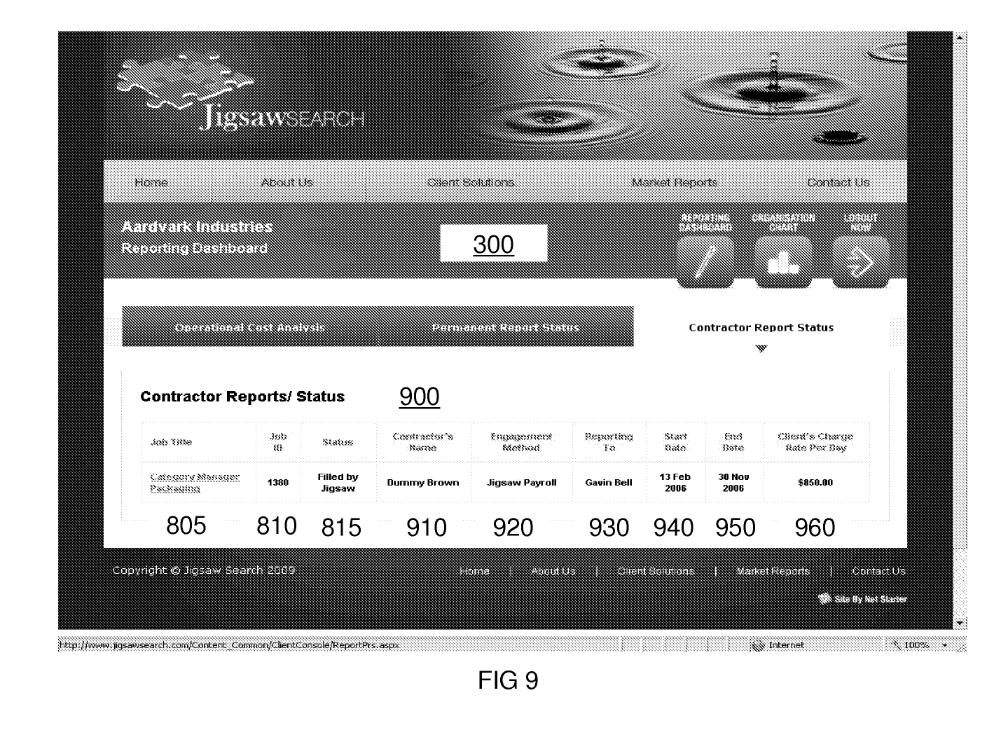

With reference to FIG. 9, GUI 300 can display report 900 relating to candidates contracted to an employer. Report 900 comprises the following for each role: field 805 comprising a role title; field 810 comprising a role ID; field 815 comprising a role status; field 910 comprising a candidate name; field 920 comprising an engagement method, e.g. recruiter's payroll; field 930 comprising a recruiter contact; field 940 comprising a contract start date; field 950 comprising a contract end date; field 960 comprising a rate per hour; and another field (not shown) comprising a cost to date for the contractor. The totals of each column in reports 800 and 900 can also be shown.

Hence, with reference to FIG. 2, according to some embodiments of the present invention, apparatus 220 for recruitment management comprises computer readable program code components 270, some of which are configured to cause the storing in the data store 280 of information relating to a plurality of potential candidates for employment in one or more roles. Some of the computer readable program code components 270 are configured to cause population of the organizational chart 310 of an employer with information relating to one or more roles with the employer and a number of the potential candidates for each role. Some of the computer readable program code components 270 are configured to cause the population of the organizational chart 310 with a number of matched candidates for each role from the number of potential candidates to indicate a level of ease or difficulty in filling the role.

With reference to FIG. 2, according to other embodiments of the present invention, system 200 for recruitment management comprises data store 280 in communication with communications network 210 for storing information relating to a plurality of potential candidates for employment in one or more roles. System 200 also comprises at least one processor 240 operatively coupled to the data store 280 for populating the organizational chart 310 of an employer with information relating to one or more roles with the employer and a number of the potential candidates for each role. Processor 240 also populates the organizational chart 310 with a number of matched candidates for each role from the number of potential candidates to indicate a level of ease or difficulty in filling the role.

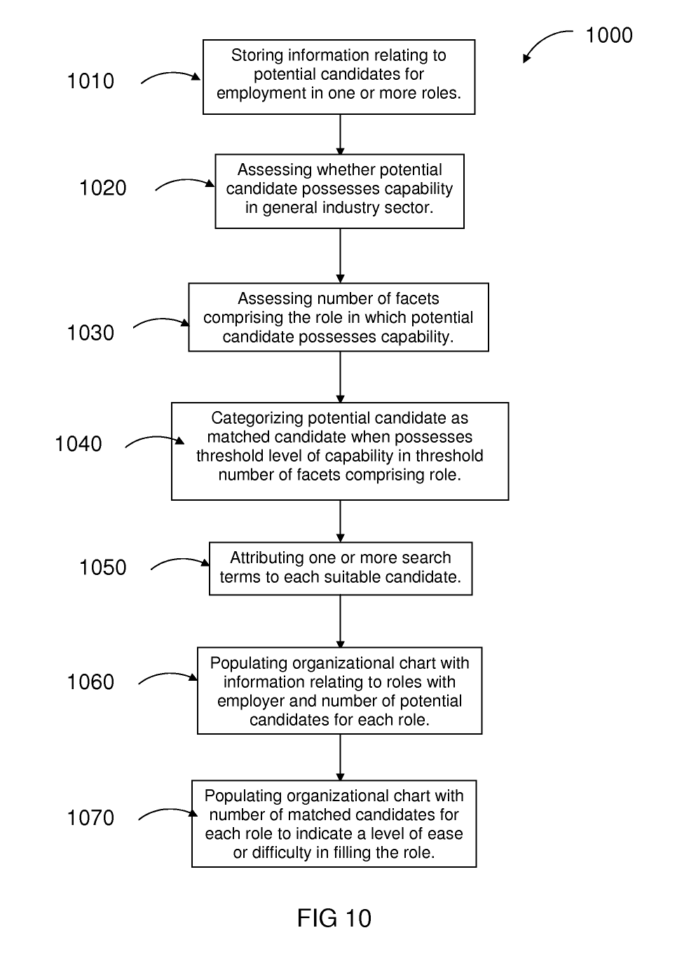

With reference to FIG. 10, according to other embodiments of the present invention, a computer-implemented method 1000 of recruitment management includes at 1010 storing in data store 280 information relating to a plurality of potential candidates for employment in one or more roles.

Method 1000 can include steps 1020 to 1050 relating to assessing and categorizing candidates as described in further detail below with reference to FIGS. 11A to 14. In summary, at 1020 the method can include assessing whether a potential candidate possesses capability in a general industry sector in which the role resides. At 1030 the method 1000 includes assessing a number of facets comprising the role in which a potential candidate possesses capability. The method 1000 includes at 1040 filtering the potential candidates and categorizing a potential candidate as a matched candidate for a role when the potential candidate possesses a threshold level of capability in a threshold number of facets comprising the role. In some embodiments, the potential candidate may need to possess the threshold level of capability in all of the facets comprising the role to be categorized as a matched candidate for the role. At 1050, for search purposes, the method can include attributing one or more search terms to each matched candidate, each search term matching a capability, attribute or experience possessed by the matched candidate to the threshold level.

Method 1000 can include at 1060 populating the organizational chart 310 of an employer with information relating to one or more roles with the employer and a number of the potential candidates for each role, the organizational chart linked to the data store 280.

At 1070, the method can include populating the organizational chart 310 with a number of matched candidates for each role from the number of potential candidates to indicate a level of ease or difficulty in filling the role.

The one or more roles may be new roles, existing roles, currently vacant roles or currently occupied roles. Hence, population of the organizational chart can be performed prior to a vacancy becoming available. Therefore, if key personnel leave an organization, embodiments of the present invention enable employers to be aware in advance of the relative ease or difficulty involved in filling the role, based on, for example, the number of potential and matched candidates available, how long it is likely to take to refill the role and the likely cost in terms of salary and recruitment fees.

The method 1000 can include, for example, the employer adding one or more potential candidates to a shortlist of matched candidates by activating icon 500 as described above.

The method 1000 can include storing in the data store the results of at least one salary survey. The method can also include populating the operational cost analysis chart 700 of an employer with an estimated additional salary derived from the salary survey which is likely to be required to match a national/market average salary for a role.

The method 1000 can also include populating the operational cost analysis chart 700 with the estimated recruitment cost to fill a role and the total cost to fill a role.

It will be appreciated that methods according to embodiments of the present invention can include steps to implement the actions described herein although not necessarily illustrated in the flow diagram in FIG. 10.

A valuable aspect of at least some embodiments of the present invention is that potential candidates have been analysed and evaluated in terms of both their technical and cultural attributes using one or more analysis techniques and/or benchmarking methods. Only potential candidates possessing a threshold level of one or more capabilities, attributes or experiences are classified as suitable candidates and it is from the resulting pool of suitable candidates that users of embodiments of the present invention, in the form of potential employers, can search for candidates to fill the employment role or vacancy. However, as described above, the employment role need not be currently vacant. Hence, a pool of potential candidates has been filtered by embodiments of the present invention into another, usually smaller, pool of suitable candidates thus streamlining the recruitment process.

FIGS. 11A-11D are schematic diagrams illustrating a method of filtering potential candidates for employment in specific role descriptions in accordance with embodiments of the present invention. FIGS. 11A-11D each show examples of role descriptions 1100, such as Category Management in FIG. 11A, Strategic Sourcing in FIG. 11B, Contract Management in FIG. 11C and Vendor Management in FIG. 11D. Each role description 1100 comprises a plurality of role facets 1110. For example, the role description of Vendor Management in FIG. 11D comprises four role facets 1110 in the form of Stakeholder Management, Dispute Resolution, Supplier Development and Key Performance Indicator (KPI) Management. Stakeholder Management and (KPI) Management are two of the five role facets 1110 which comprise the role description of Contract Management shown in FIG. 11C. The remaining three role facets 1110 for the role description of Contract Management are Transition Strategy, Performance Review Strategy and Risk Management. Whilst each role description 1100 shown in FIGS. 11A-11D comprises a plurality of role facets 1110, it is envisaged that some role descriptions 1100 may comprise a single role facet 1110.

Candidates can have a range of skills and experience such that they can be classified in a plurality of role descriptions 1100. For example, with reference to FIGS. 11C and 11D, a potential candidate possessing capability in the role facets 1110 of Stakeholder Management, Dispute Resolution, Supplier Development, KPI Management, Transition Strategy, Performance Review Strategy and Risk Management would be classified as having both of the role descriptions 1100 of Contract Management and Vendor Management.

Some embodiments of the present invention comprise assessing whether a potential candidate possesses capability and quantifiable achievements in a threshold number of the facets 1110 comprising the role description 1100. The present invention does not merely rely on job titles or labels previously attributed to the potential candidate by other businesses or by the potential candidate themselves, for example, if they have previously been self-employed. According to some embodiments, the threshold number of the facets 1110 is 100% such that potential candidates must possess capability in all of the facets 1110 comprising the role description 1100 before the potential candidates are classified as possessing the role description 1100. According to other embodiments, potential candidates must possess capability in, for example, 80% of the facets 1110 comprising the role description 1100 before the potential candidates are classified as possessing the role description 1100. Where candidates comprise, for example, 4 out of 5 of the facets 1110 comprising the role description 1100, the suitable candidate may be classified in tiers or strata as described below.

However, according to some embodiments, before a potential candidate can be classified as a suitable candidate, the potential candidate must not only possess capability in a threshold number of the facets 1110, but must also possess a threshold level of capability in the threshold number of role facets 1110 comprising the role description 1100. The threshold level can be set according to a predetermined categorization or classification level. For example, a premier group of candidates may be referred to as Tier 1 and comprise the best possible candidates available in a particular role description. For Tier 1, the threshold level of capability in the role facets 1110 can be set at a highest level, for example, scoring 90%+ in each of the role facets 1110 to be able to qualify. Multiple tiers may be used and employers may select a particular tier as one of their search criterion. For example, potential candidates may be classified as suitable candidates for Tier 2 if their score in each of the role facets 1110 is between the threshold levels of 81-90%. Higher tier candidates are likely to command higher salaries and the option of selecting a particular tier enables potential employers to balance candidate quality with candidate remuneration.

It will be appreciated that the threshold levels can be varied and set as desired. For example, according to some embodiments, whilst a potential candidate may not possess capability in each of the role facets 1110, the potential candidate may score highly in 80% of the role facets 1110 and therefore still be classified as a Tier 1 suitable candidate. Alternatively, a potential candidate may possess capability in all of the role facets 1110, but only score 71-80% in each role facet and thus be classified as a Tier 3 suitable candidate.

Scoring of candidates in each of the role facets 1110 can be carried out using one or more of the following approaches. Personal interviews and/or discussions with the potential candidate can be conducted. Psychometric testing and/or reasoning testing and/or other testing can be conducted manually and/or electronically via one of the computing devices 100. According to some embodiments, the potential candidate checks boxes according to the capabilities, attributes, and/or experiences they possess with further levels of enquiry, such as direct personal experience, supervising others in particular roles and the like. A level of attractiveness of the potential candidate to potential employers for a particular role description can also be considered.

In one particular embodiment, candidates are assessed via a test answered electronically by the candidate via one of the computing devices 100. The test is compiled for the particular role being assessed and in some embodiments is a multiple choice test comprising a plurality of questions. Each question is designed to assess the candidate's capability in one or more facets of the role for which the candidate is being assessed. Some embodiments of the systems, methods and apparatus of the present invention include attributing a score to the candidate indicative of the candidate's level of capability for the role. The score is based on the candidate's responses to the plurality of questions.

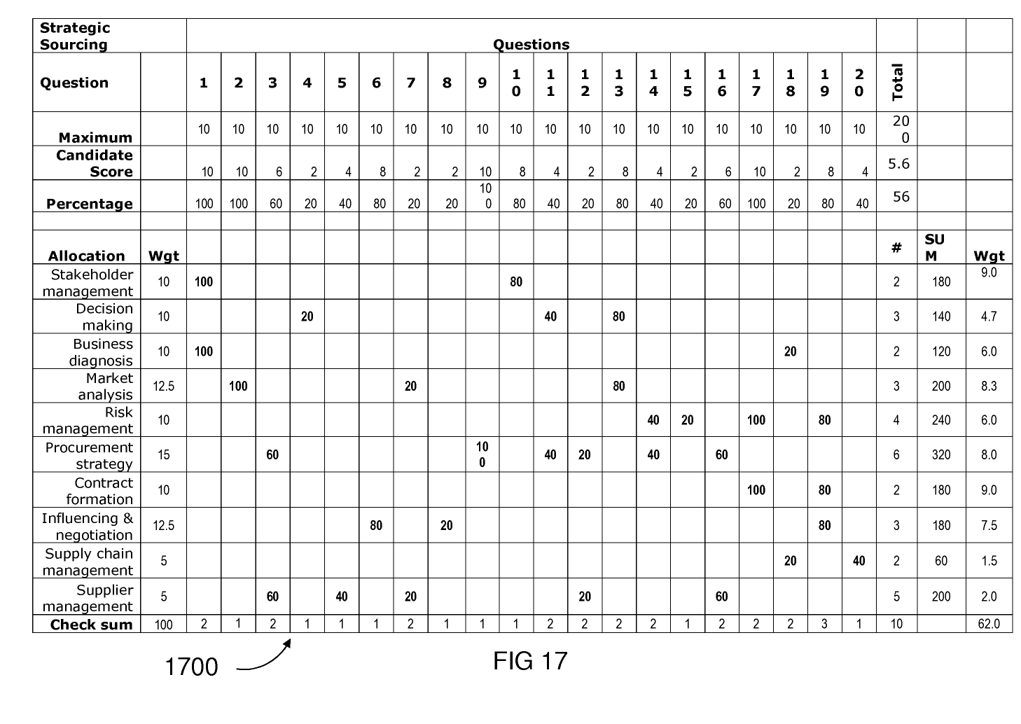

An example of a score sheet 1700 for assessing a candidate is shown in FIG. 17. In this example, the role is strategic sourcing which comprises ten facets. The text comprises twenty questions, each with a maximum score of ten. Score sheet 1700 shows the candidate's score for each question and that score as a percentage of the maximum. Each facet has a different weighting in relation to the role of strategic sourcing. In this example, the facet of supply chain management has a 5% weighting, contract formation a weighting of 10%, procurement strategy a weighting of 15% and so on such that the weightings total 100%.

In this example, the first question assesses the role facets of stakeholder management and business diagnosis and since the candidate scored 100% for the first question, these two facets are given a score of 100. The tenth question also assesses stakeholder management and the candidate's score for the tenth question was 80%. Therefore, this facet is given a score of 80 for this question. For the facet of stakeholder management, the candidate scored a total of 180 from two questions and therefore in this example, the candidate's weighted score for this facet is 9.0 (180/2*10%). Embodiments of the systems, methods and apparatus of the present invention include calculating the weighted score for each facet comprising the role and summing the weighted scores to determine the candidate's score for the role, which in the example shown is 62.0. The score therefore provides a quantified assessment of the candidate's capability in the role that does not rely on the candidate's opinion of their own capabilities or the recruiter's opinion.

The weightings can be adjusted, for example according to whether the role is a junior role, a mid-level role, a senior role or an expert role or the like. In some scenarios, although the role usually comprises a particular facet, a potential employer may have a role in which one or more particular facets are of a low priority or irrelevant. In such scenarios, the weighting for the low priority or irrelevant facet can be set to a suitably low or zero level. Therefore, if a candidate scored highly in all the facets that were important, a low score in the low priority or irrelevant facet(s) would only impact minimally or not at all on the candidate's overall score for the role, thus ensuring they would be categorized as a suitable candidate.

In some embodiments, the candidate's score for each facet of the role can be compared against the ideal or threshold scores for each facet and displayed graphically to efficiently demonstrate to the potential employer, recruiter and/or potential candidate how the candidate compares against the requirements for the role. Embodiments of the invention can include providing the candidate with feedback on their assessment including the facets in which the candidate requires improvement in order to reach the threshold levels for each facet.

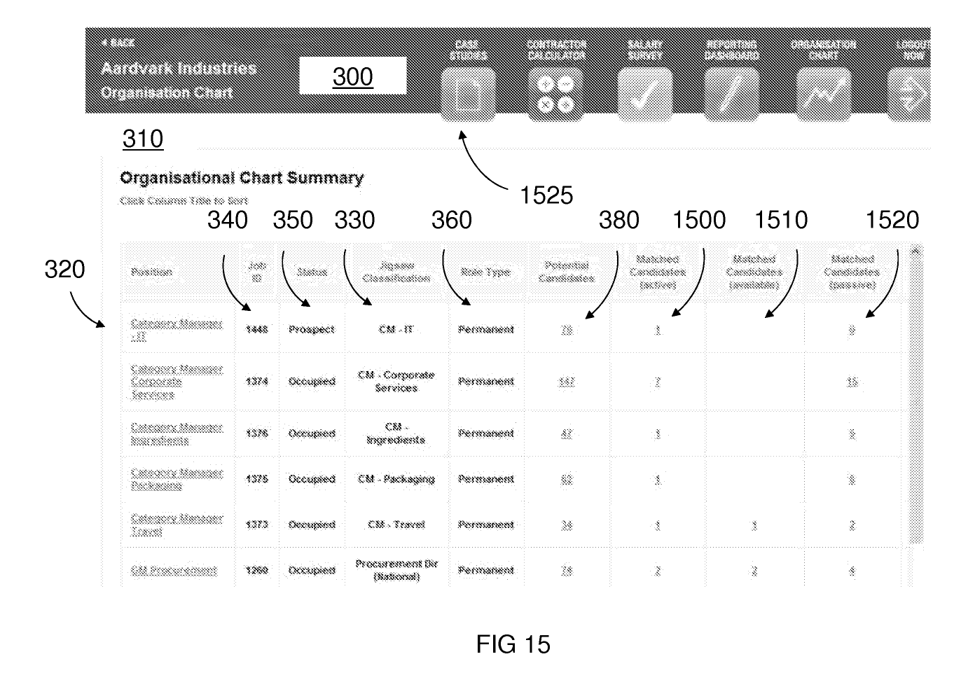

In some embodiments, potential employers can access and view the test results for candidates by activating case studies icon 1525 of the organisational chart 310 displayed via the GUI 300, as shown in FIG. 15.

Embodiments of the system, method and apparatus of the present invention can further include determining a value for money of the candidate by calculating a ratio of a current salary for the candidate to the candidate's score indicative of the candidate's level of capability for the role. This calculation enables potential employers and recruiters to determine the potential candidates and current employees who are currently underpaid or overpaid for their capability level for a particular role or conversely those who are under-skilled or over-skilled for their current remuneration.

Candidates can be ranked according to their value for money and divided into categories, such as quartiles, for the easy determination of those candidates that represent, for example, good, average or poor value for money.

Hence, by virtue of the present invention, potential employees will be able to quantifiably determine how easy or difficult it will be to fill a vacant role or replace someone in a currently occupied role from the external market of candidates or from candidates within their organization, how much they are likely to need to pay the candidate and whether the level of capability the candidate will bring to the role. Furthermore, recruiters have a quantifiable basis for feedback and why they are or are not putting forward candidates for particular roles.

Once capabilities in the threshold number of role facets 1110 have been identified and scored and the threshold level of capability in the threshold number of facets 1110 satisfied, the candidate is categorized as a suitable candidate. Where multiple tiers are being employed, the suitable candidate is also classified in the appropriate tier, such as Tier 1, Tier 2 etc., according to their scores.

To facilitate effective searching of suitable candidates, one or more search terms are attributed to each suitable candidate. Each search term matches a capability, attribute or experience possessed by the suitable candidate to the threshold level. Examples of search terms in the fields of procurement and supply chain that may be attributed to suitable candidates depending on the capabilities possessed to the threshold level are shown in the Appendix. The Appendix also shows examples of role definitions 1100 in the fields of procurement, supply chain, category management, purchasing, logistics, planning, analytics and consulting. The Appendix also shows examples of industry definitions used in embodiments of the present invention in order to align procurement and supply chain practitioners with common environmental and cultural experiences whilst providing potential employers sufficient diversity to identify candidates with more specific industry experience.

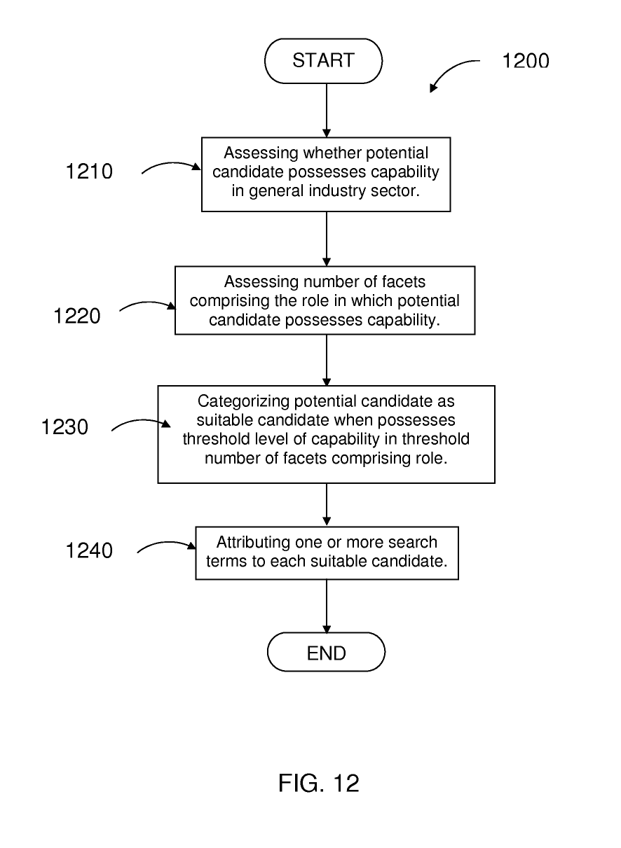

Hence, with reference to the general flow diagram in FIG. 12, according to one aspect, embodiments of the present invention reside in a method 1200 of filtering potential candidates for employment in a role description including at 1220 assessing a number of facets comprising the role in which a potential candidate possesses capability. At 1230, the method includes categorizing a potential candidate as a suitable candidate for the role when the potential candidate possesses a threshold level of capability in a threshold number of the facets comprising the role. The method 1200 includes at 1240 attributing one or more search terms to each suitable candidate, each search term matching a capability, attribute or experience possessed by the suitable candidate to the threshold level. According to some embodiments, the method also includes at 1210 assessing whether a potential candidate possesses capability in a general industry sector in which the role resides.

According to some embodiments, users can register with the system 200 and open an account via the website 230. Registration can be implemented by any suitable means familiar to those skilled in the art and can include recording user details, requiring acceptance of terms and conditions of use of the website 230 and known security measures. Payment for use of the candidate short-listing system 200, method 1200, apparatus 220 and graphical user interface 1300 may also be made via the website 230.

Once suitable candidates have been categorized and their information stored in the data store 280, the methods of recruitment management as described above can be performed.

Once suitable candidates have been categorized and their information stored in the data store 280, alternatively users in the form of potential employers can access the data store 280 from their computing device 100 via communications network 210 and the website 230. A user can search the data store 280 by submitting a search query via the website 230 to cause the data store 280 to be interrogated to search for candidates matching the search criteria. The returned search results can include one or more of the aforementioned items of information and/or other information stored for each candidate where at least one search term for the candidate matches at least one search criterion of the search query submitted by the user.

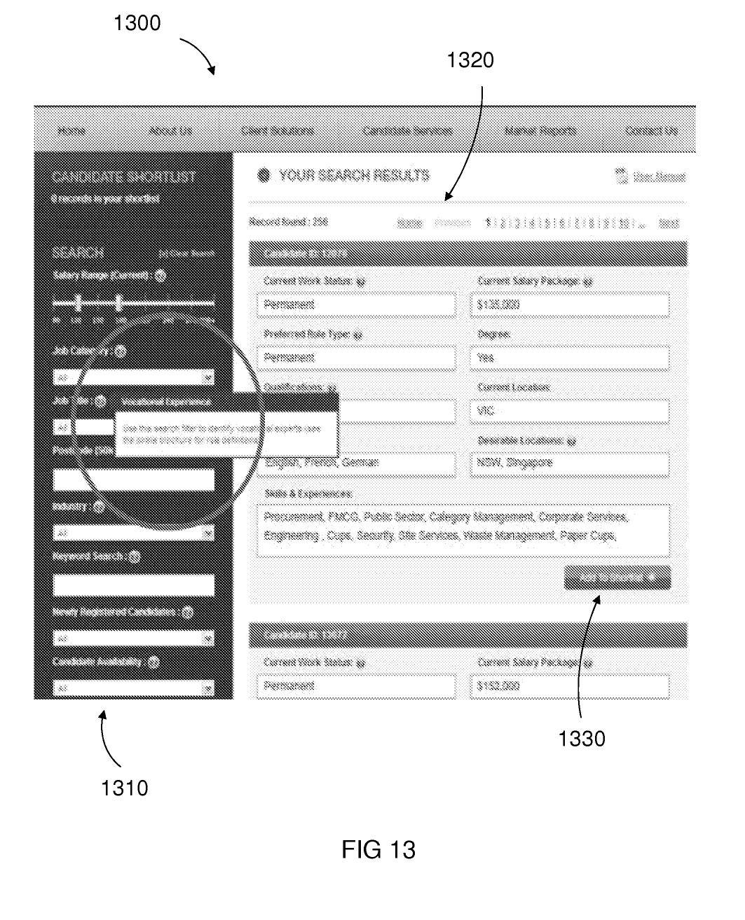

Referring to FIG. 13, a screenshot illustrates a graphical user interface 1300 in accordance with some embodiments of the present invention, which facilitates searching for suitable candidates. The graphical user interface 1300 is displayed on the output device 130, such as a screen, of computing device 100, once a user has accessed the website 230 and logged in with a username and password or similar established during registration.

The graphical user interface 1300 displays one or more fields 1310 for receiving or selecting one or more search criteria of a search query submitted by a potential employer via the website 230. The search criteria can include one or more of the following: Job Category; Job Title; Salary; Salary Range; Industry; Location, such as within a specified distance of a particular location, e.g. within 50 km of the CBD of a specified city; Candidate Availability; Newly Registered Candidates, such as candidates registered within a specified time period; Keywords of the user's choosing; Keywords selected from the list of search terms in the Appendix.

In FIG. 13, the graphical user interface 1300 also displays an example of search results 1320 returned from the data store 280 in response to the search query. The search results 1320 in this example comprise 256 records, with one record corresponding to one suitable candidate. Each record comprises an identifier in the form of a Candidate ID for a suitable candidate retrieved from the data store where at least one search term attributed to the suitable candidate matches the one or more search criteria of the search query. As described above, the data store 280 stores one or more search terms for each suitable candidate, each search term matching a capability, attribute or experience possessed by the suitable candidate when the suitable candidate possesses a threshold level of capability in a threshold number of facets 1110 comprising the role description 1100.

In the example shown in FIG. 13, the graphical user interface 1300 displays the first record of the search results and a portion of the second record. The first record is for Candidate ID: 12976, who has a current work status of permanently employed, a preferred role type of permanent employment, qualifications, languages of English, French and German, a current salary package of $135,000, a degree, a current working location of Victoria, Australia, desirable working locations of New South Wales, Australia and Singapore and a list of skills and experience. According to preferred embodiments, the skills and experience of each candidate are in the form of one or more search terms attributed to each suitable candidate and matching a capability, attribute or experience possessed by the suitable candidate to the threshold level. Graphical user interface 1300 also displays an actuatable indicium 1330 that enables a user to add the record for the candidate to their shortlist, thus further refining the selection process.

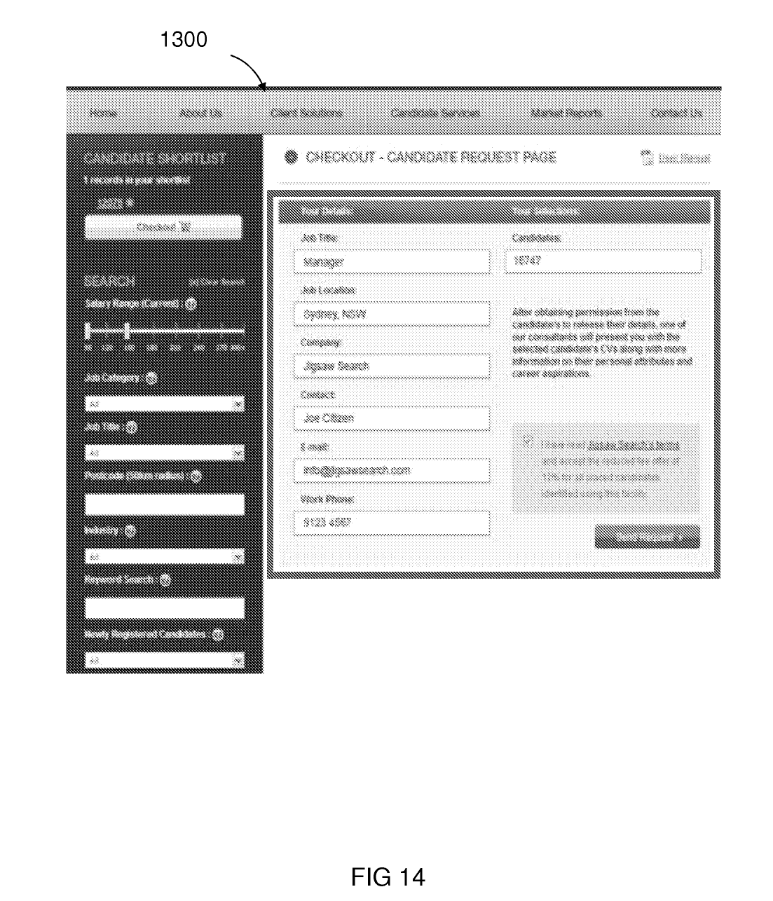

Referring to FIG. 14, a screenshot illustrates the graphical user interface 1300 displaying a candidate request page via which the potential employer submits their basic information and contact details in order to receive further information relating to the suitable candidates shortlisted by the potential employer. Once permission has been obtained from the shortlisted candidate(s), an authorized CV and further information, such as a summary of the candidate's current circumstances, experiences and personal expectations, are sent to the potential employer, for example via email.

According to some embodiments, a reporting structure is available to potential employers who have used embodiments of the present invention. The reporting structure enables potential employers to list and view the number of candidates they have recruited using embodiments of the invention, the recruitment fees paid and the search criteria used for the searches, which can be saved and used for further searches to further streamline the process.

According to some embodiments, each potential employer registered with the system is allocated a unique identifier or similar. If a suitable candidate expresses a desire to work for a particular potential employer registered with the system, the information stored in the data store 280 for that suitable candidate can include the unique identifier for the potential employer or similar identifier of the company of interest. If and when the potential employer conducts a search, the suitable candidate can be listed in the search results. Alternatively, a notification of the candidate's desire to work for a particular potential employer can be sent to the potential employer independently of a search being conducted by the potential employer on the system.

FIG. 15 shows an alternative embodiment of the GUI 300 and the organizational chart 310 displayed via the GUI 300. In this embodiment, organizational chart 310 comprises fields of previous embodiments including searchable fields 320 each comprising a role or position with the company, role classification fields 330, fields 340 comprising Job IDs, fields 350 comprising a status of each role, fields 360 comprising a role type and searchable fields 380 comprising a number of potential candidates for each role selected from the data store 280, as described above.

In this embodiment, the number of matched candidates selected from the number of potential candidates are categorized in a plurality of different categories. In some embodiments, the plurality of different categories relate to the status of the candidates. In the embodiment shown in FIG. 15, organizational chart 310 comprises three searchable fields or actuatable icons for each role relating to the status of the matched candidates for each role selected from the number of potential candidates. Organizational chart 310 comprises a first searchable field or actuatable icon 1500 for active matched candidates, a second searchable field or actuatable icon 1510 for available matched candidates and a third searchable field or actuatable icon 1520 for passive matched candidates. Active matched candidates are currently employed, but looking for a new role. Available matched candidates are not currently employed and are looking for a role. Passive matched candidates are not looking for a new role. This categorization is derived from the status of each candidate currently stored in the database 280.

The first, second and third searchable fields or actuatable icons display the number of matched candidates of each respective status. For example, as shown in FIG. 15, for the currently occupied role of GM Procurement with Aardvark Industries, of the 74 potential candidates in the system there are a total of 8 candidates that have been matched to the role in accordance with the methods and protocols described herein. Two of the matched candidates are active, two of the matched candidates are available and four of the matched candidates are passive. Hence, the employer is further informed of the ease or difficulty in filling the role. Actuation of the relevant number displays further details of the particular active, available or passive matched candidates as described above. The total number of matched candidates can also be displayed in this embodiment.

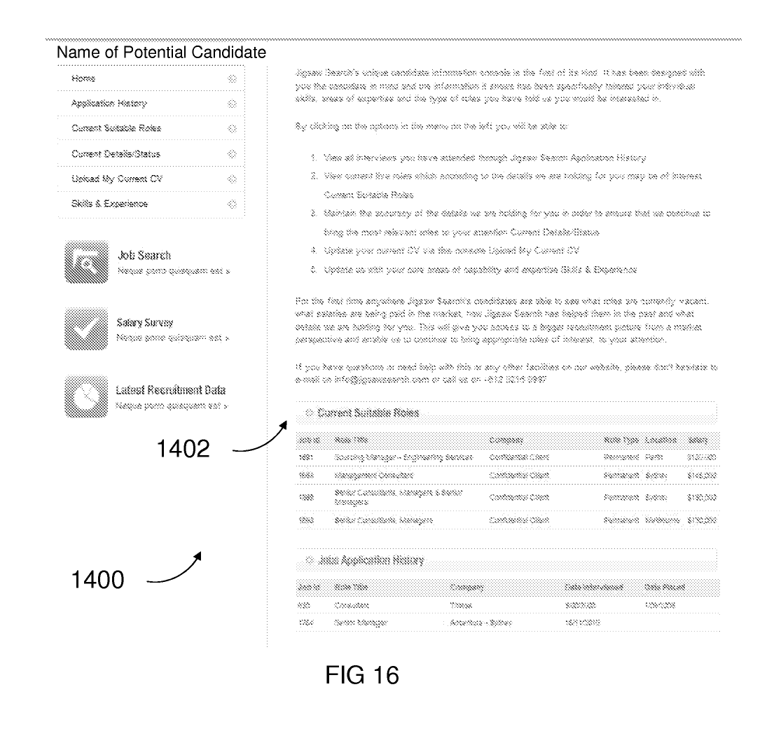

With reference to FIG. 16, according to another aspect of the present invention, there is provided a candidate graphical user interface (GUI) 1400 for recruitment management for potential candidates registered with the system. The GUI 1400 is in communication with the electronic data store in the form of database 280, which stores information relating to a plurality of employment roles and a plurality of potential candidates for employment in one or more of the roles, as described herein. Potential candidates registered with the system and whose details are stored in database 280 have been analysed and evaluated in accordance with the analysis techniques described herein. Only potential candidates possessing a threshold level of one or more capabilities, attributes or experiences relating to roles are classified as suitable candidates. It is from the resulting pool of suitable candidates that users of embodiments of the present invention, in the form of potential employers and potential candidates, can search for candidates or roles respectively.

Once the potential candidate logs in, GUI 1400 automatically displays to a potential candidate information relating to at least one role that has been matched to the potential candidate. These are shown in FIG. 16 as current suitable roles 1402 and four such roles are shown for this particular potential candidate.

In accordance with embodiments of the present invention, the potential candidate has been matched to the at least one role on the basis of a plurality of matching criteria relating to the role and to the potential candidate. One criterion that must be matched for a role to be displayed as a suitable role is a role ID. The role ID depends on the requirements for the role as entered into the system, which must match the role ID sought by the potential candidate.

Another criterion that must be matched for a role to be displayed as a suitable role is selected from a location criterion and/or a salary criterion. The location criterion requires a match between the location of the role and one or more of the following: a location in which the potential candidate resides and/or a location in which the candidate wishes to work. The salary criterion requires a match between a salary being offered for the role and a salary desired by the potential candidate within a predetermined amount. The predetermined amount can be a dollar amount, such as above or below $10,000, or a percentage, such as ±10%.

According to some embodiments, the at least one suitable role is automatically displayed to the potential candidate on the basis of all three criteria being matched between the role and the potential candidate.

As shown in FIG. 16, the information displayed to the potential candidate relating to at least one role matched to the potential candidate includes one or more of the following: a role; a role ID, a company name; a role status; a role type; a location; a salary; a start date for the role. In one of the examples shown, the current suitable role has a Job ID of 1691, a role of Sourcing Manager—Engineering Services, a role type of permanent, the location of the role is Perth and the salary offered for the role is $130,000. The company name is confidential at this stage. Hence, accurately categorised roles are automatically brought to the attention of pre-vetted, filtered potential candidates based on matching core criteria of the role and the candidate. The current suitable roles are constantly updated according to the roles and the potential candidates.

The graphical user interface 1400 can further display information relating to a role application history for the potential candidate, such as, but not limited to one or more of the following: a role; a role ID; a company name; an interview date; a placement date. The GUI 1400 also enables potential candidates to upload their current CV and update their skills and/or experience to maintain the accuracy and currency of the information stored in database 280.

One or more of the fields of information displayed in graphical user interface 1400 can be displayed as an actuatable icon or searchable field that enables the potential candidate to view further details relating to displayed information.

Hence, the systems, methods, apparatus and graphical user interfaces according to embodiments of the present invention as described herein thus provide a solution to the aforementioned problems of the prior art by providing data store 280 comprising a pool of pre-vetted and categorized potential candidates from which candidates can be matched to roles provided by employers on their respective organizational charts 310 displayed on the GUI 300.

Organizational charts 310 display a number of potential candidates and a number of matched candidates for each role informing employers in advance of the relative ease or difficulty likely to be involved in filling the role. This is supplemented with other data such as how long it is likely to take to refill the role and the likely cost in terms of salary and recruitment fees.

Reports 800 and 900 allow both employers and recruiters to quickly and easily track costs and fees for recruiting and likely times required to fill roles enabling employers and recruiters to plan, budget and fill roles with matched candidates more effectively. The data store 280 is regularly updated which feeds into the GUI 300. Therefore, the GUI 300 provides employers and recruiters with up-to-the minute reports and a live status for each role. This reduces the burden on recruiters who often have to provide monthly reports to employers regarding costs and role status.

Furthermore, employers do not need to go to the market to seek candidates because at least some embodiments of the present invention provide a data store of pre-filtered and categorized potential candidates from the external market from which matches can be sought. Hence, the employer does not need to waste time and expense advertising.

Potential candidates are quantifiably assessed regarding their capabilities for a role and whether they possess a threshold level of capability in a threshold number of facets 1110 comprising the role description 1100. The potential candidate is then categorized as a suitable candidate for the role description when the potential candidate possesses a threshold level of capability in the threshold number of the facets comprising the role. Consequently, the potential employer can search and review a smaller pool of pre-vetted, high quality candidates via GUI 1300 rather than having to screen a larger number of applications from candidates having a potentially wide range of qualities and suitability for the role.

The potential employer can quickly identify a further refined shortlist of candidates from the search process described herein and promptly receive details of the shortlisted candidates. The time taken to appoint a suitable, high quality candidate is significantly reduced and the likelihood of the appointed candidate being unsuitable for the role is vastly reduced due to the filtering process. The duration for which a role remains vacant is also reduced, thus minimizing the impact on productivity of the employer. Since the employer is conducting some of the searching, a recruitment agency offering the search facility can discount the cost of their recruitment services. Potential employers are also able to dramatically reduce their advertising spend since suitable candidates tailored to role descriptions have been pre-sourced and quantifiably vetted.

If an employer receives too few matched candidates, this may be because the role description was too specific. The role description can therefore be amended to capture more of the potential candidates as matches. Conversely, if too many matched candidates are retrieved, the role description can be amended to be more specific to capture fewer potential candidates as matches who will be even more tailored to the role.

GUI 1400 also enables potential candidates to be automatically informed of current suitable roles that have been matched to the pre-vetted, filtered potential candidates on the basis of the role criterion and one or more of the location criterion and/or the salary criterion.

Hence, embodiments of the present invention benefit users and society as a whole by facilitating prompt recruitment of high quality, pre-vetted candidates enabling companies to fulfill their productivity capabilities and objectives sooner and reduce their recruitment times and costs thus contributing to the economic benefit of each country in which embodiments of the invention are implemented.

Throughout the specification the aim has been to describe the invention without limiting the invention to any one embodiment or specific collection of features. Persons skilled in the relevant art may realize variations from the specific embodiments that will nonetheless fall within the scope of the invention.

1. A computer-implemented method of recruitment management, the method including:
storing in an electronic data store information relating to a plurality of potential candidates for employment in one or more roles;
populating an electronic organizational chart of an employer with information relating to one or more roles with the employer and a number of the potential candidates for each role, the organizational chart linked to the data store; and
populating the electronic organizational chart with a number of matched candidates for each role from the number of potential candidates to indicate a level of ease or difficulty in filling the role;
wherein the number of matched candidates are categorized in a plurality of different categories.

2. The method of claim 1, wherein the plurality of different categories relate to the status of the matched candidates.

3. The method of claim 1, wherein the electronic organizational chart comprises a plurality of searchable fields relating to the status of the matched candidates for each role.

4. The method of claim 3, wherein the electronic organizational chart comprises:
a first searchable field for active matched candidates;
a second searchable field for available matched candidates; and
a third searchable field for passive matched candidates.

5. The method of claim 1, wherein the one or more roles are one of the following: new roles; existing roles; currently vacant roles; currently occupied roles.

6. The method of claim 1, further including adding one or more potential candidates to a shortlist of the matched candidates upon actuation of a displayed icon.

7. The method of claim 1, further including filtering the potential candidates and categorizing a potential candidate as a matched candidate for a role when the potential candidate possesses a threshold level of capability in a threshold number of facets comprising the role.

8. The method of claim 7, wherein filtering potential candidates includes assessing a number of facets comprising the role in which a potential candidate possesses capability.

9. The method of claim 8, further including categorizing a potential candidate as a matched candidate for the role when the potential candidate possesses the threshold level of capability in all of the facets comprising the role.

10. The method of claim 7, further including attributing one or more search terms to each matched candidate, each search term matching a capability, attribute or experience possessed by the matched candidate to the threshold level.

11. The method of claim 1, further including assessing whether a potential candidate possesses capability in a general industry sector in which the role resides.

12. The method of claim 1, further including populating an operational cost analysis chart of an employer with an estimated additional salary derived from a salary survey stored in the electronic data store and required to match an average salary for a role.

13. The method of claim 12, further including populating the operational cost analysis chart with one or more of the following: an estimated recruitment cost to fill a role; a total cost to fill a role.

14. The method of claim 1, further including populating a report relating to candidates engaged by an employer with one or more of the following: a role; a role ID, a role status; a role type; a hiring manager; a number of matched candidates sent to the employer; a number of matched candidates interviewed by the employer; a number of days before receiving a CV; a number of days until the candidate is interviewed by the employer; a number of days taken to fill the role; a start date for the role, a fee paid for filling the role; a percentage of annual salary represented by the fee; a candidate name; an engagement method; a contract start date; a contract end date; a rate per hour; a cost to date.

15. An apparatus for recruitment management comprising computer readable program code components configured to cause:
storing in an electronic data store information relating to a plurality of potential candidates for employment in one or more roles;
populating an electronic organizational chart of an employer with information relating to one or more roles with the employer and a number of the potential candidates for each role, the organizational chart linked to the data store; and
populating the electronic organizational chart with a number of matched candidates for each role from the number of potential candidates to indicate a level of ease or difficulty in filling the role, wherein the number of matched candidates are categorized in a plurality of different categories.

16. The apparatus of claim 15, further comprising computer readable program code components configured to cause the electronic organizational chart to comprise a plurality of searchable fields relating to the status of the matched candidates for each role.

17. The apparatus of claim 16, wherein the electronic organizational chart comprises:
a first searchable field for active matched candidates;
a second searchable field for available matched candidates; and
a third searchable field for passive matched candidates.

18. A system for recruitment management comprising:
an electronic data store in communication with a communications network for storing information relating to a plurality of potential candidates for employment in one or more roles; and
at least one processor operatively coupled to the data store for:
populating an electronic organizational chart of an employer with information relating to one or more roles with the employer and a number of the potential candidates for each role; and
populating the electronic organizational chart with a number of matched candidates for each role from the number of potential candidates to indicate a level of ease or difficulty in filling the role, wherein the number of matched candidates are categorized in a plurality of different categories.

19. The system of claim 18, wherein the electronic organizational chart comprises a plurality of searchable fields relating to the status of the matched candidates for each role.

20. The system of claim 18, wherein the electronic organizational chart comprises:
a first searchable field for active matched candidates;
a second searchable field for available matched candidates; and
a third searchable field for passive matched candidates.

21. A graphical user interface for recruitment management in communication with an electronic data store storing information relating to a plurality of potential candidates for employment in one or more roles, the graphical user interface displaying:
one or more fields comprising information relating to one or more roles with an employer;
a searchable field comprising a number of potential candidates for each role selected from the data store; and
a plurality of searchable fields comprising a number of matched candidates for each role selected from the number of potential candidates to indicate a level of ease or difficulty in filling the role, wherein each searchable field relates to the status of the matched candidates for each role.

22. The graphical user interface of claim 21, wherein the plurality of searchable fields comprises:
a first searchable field for active matched candidates;
a second searchable field for available matched candidates; and
a third searchable field for passive matched candidates.

23. The graphical user interface of claim 21, wherein activation of one of the fields comprising information relating to a role with the employer causes the graphical user interface to display further information relating to the role.

24. The graphical user interface of claim 21, wherein actuation of an icon causes the graphical user interface to display at least one record of one of the potential candidates for the role.

25. The graphical user interface of claim 21, wherein actuation of an icon causes the graphical user interface to display at least one record of one of the matched candidates for the role.

26. A graphical user interface for recruitment management in communication with an electronic data store storing information relating to a plurality of roles and a plurality of potential candidates for employment in one or more of the roles, the graphical user interface displaying to a potential candidate information relating to at least one role matched to the potential candidate;
wherein the potential candidate has been matched to the at least one role on the basis of a plurality of matching criteria relating to the role and to the potential candidate, one of the criterion being a role ID and another of the criterion being selected from one or more of the following: a location criterion and/or a salary criterion.

27. The graphical user interface of claim 27, wherein the location criterion is one or more of the following: a location in which the potential candidate resides and/or a location in which the candidate wishes to work.

28. The graphical user interface of claim 27, wherein the salary criterion includes a salary for the role being within a predetermined amount of a salary desired by the potential candidate.

29. The graphical user interface of claim 27, wherein the information relating to at least one role matched to the potential candidate includes one or more of the following:
a role; a role ID, a company name; a role status; a role type; a location; a salary; a start date for the role.

30. The graphical user interface of claim 27, further displaying information relating to a role application history for the potential candidate.

31. The graphical user interface of claim 30, wherein the information relating to the role application history includes one or more of the following: a role; a role ID; a company name; an interview date; a placement date.

32. A computer-implemented method of short-listing one or more suitable candidates for employment in a role, the method including:
storing in an electronic data store one or more search terms for each suitable candidate, each search term matching a capability, attribute or experience possessed by the suitable candidate, wherein each suitable candidate possesses a threshold level of capability in a threshold number of facets comprising the role;
receiving a search query submitted by a potential employer via a website in communication with the data store, the website accessible via a computing device in communication with a communications network; and
retrieving information for at least one suitable candidate from the data store in response to the search query where at least one search term for the suitable candidate matches at least one search criterion of the search query.

33. An apparatus for short-listing one or more suitable candidates for employment in a role, the apparatus comprising computer readable program code components configured to cause:
storing in an electronic data store one or more search terms for each suitable candidate, each search term matching a capability, attribute or experience possessed by the suitable candidate, wherein each suitable candidate possesses a threshold level of capability in a threshold number of facets comprising the role;
receiving a search query submitted by a potential employer via a website in communication with the data store, the website accessible via a computing device in communication with a communications network; and
retrieving information for at least one suitable candidate in response to the search query where at least one search term for the suitable candidate matches at least one search criterion of the search query.

34. A system for short-listing one or more suitable candidates for employment in a role, the system comprising:
an electronic data store in communication with a communications network for storing one or more search terms for each suitable candidate, each search term matching a capability, attribute or experience possessed by the suitable candidate, wherein each suitable candidate possesses a threshold level of capability in a threshold number of facets comprising the role; and
at least one processor operatively coupled to the data store for:
receiving a search query submitted by a potential employer via a website in communication with the data store, the website accessible via a computing device in communication with a communications network; and
retrieving information for at least one suitable candidate in response to the search query where at least one search term for the suitable candidate matches at least one search criterion of the search query.

35. A graphical user interface for short-listing one or more suitable candidates for employment in a role, the graphical user interface displaying:
one or more fields for receiving or selecting one or more search criteria of a search query submitted by a potential employer via a website, the website accessible via a computing device in communication with a communications network;
information for at least one suitable candidate retrieved from an electronic data store in response to the search query where at least one search term for the suitable candidate matches the one or more search criteria of the search query, wherein the data store stores one or more search terms for each suitable candidate, each search term matching a capability, attribute or experience possessed by the suitable candidate when the suitable candidate possesses a threshold level of capability in a threshold number of facets comprising the role.

36. A method of filtering potential candidates for employment in a role, the method including:
assessing a number of facets comprising the role in which a potential candidate possesses capability; and
categorizing a potential candidate as a suitable candidate for the role when the potential candidate possesses a threshold level of capability in a threshold number of the facets comprising the role.

37. The method of claim 36, further including categorizing the potential candidate as a suitable candidate for the role if the potential candidate possesses the threshold level of capability in all of the facets comprising the role.

38. The method of claim 36, further including attributing one or more search terms to each suitable candidate, each search term matching a capability, attribute or experience possessed by the suitable candidate to the threshold level.

39. The method of claim 36, further including assessing whether a potential candidate possesses capability in a general industry sector in which the role resides.

40. The method of claim 36, further including attributing a score to the candidate indicative of the candidate's level of capability for the role, wherein the score is based on the candidate's responses to a plurality of questions, each question assessing the candidate's capability in at least one facet of the role.

41. The method of claim 40, wherein the score indicative of the candidate's level of capability for the role is based on the sum of weighted scores for each facet comprising the role.

42. The method of claim 40, further including providing the candidate with feedback on their assessment including a comparison of the candidate's scores with ideal scores for each facet of the role.

43. The method of claim 40, further including determining a value for money of the candidate by calculating a ratio of a current salary for the candidate to the candidate's score indicative of the candidate's level of capability for the role.

44. An apparatus for recruitment management comprising computer readable program code components configured to cause:
storing in an electronic data store information relating to a plurality of potential candidates for employment in one or more roles;
attributing a score to the candidates indicative of the candidates' level of capability for the role, wherein the score is based on the candidate's responses to a plurality of questions, each question assessing the candidate's capability in at least one facet of the role; and
populating an electronic organizational chart of an employer linked to the data store with:
information relating to one or more roles with the employer;
a number of the potential candidates for each role; and
a number of matched candidates for each role selected from the number of potential candidates to provide an employer with an indication of a level of ease or difficulty in filling the role.
